(19) United States
(12) Patent Application Publication
(10) Pub. No.: US 2014/0118419 A1
(43) Pub. Date: May 1, 2014

(54) COLOR FILTER SUBSTRATE HAVING TOUCH-SENSING FUNCTION

(71) Applicant: WINTEK CORPORATION, Taichung City (TW)

(72) Inventors: Yi-Chun Wu, Hualien County (TW); Yu-Chen Liu, Taipei City (TW); Wun-Yi Shie, Taichung City (TW)

(73) Assignee: WINTEK CORPORATION, Taichung City (TW)

(21) Appl. No.: 14/062,908

(22) Filed: Oct. 25, 2013

(30) Foreign Application Priority Data
Oct. 26, 2012 (TW) 101139699

(51) Int. Cl. G09G 3/20

(52) U.S. Cl. CPC G09G 3/2003
USPC 345/690; 345/55

(57) ABSTRACT

The present invention provides a color filter substrate with a touch-sensing function including a substrate, a black matrix, a plurality of color filters, and a patterned common electrode layer. The substrate has a plurality of pixel regions arranged as a matrix, and each pixel region includes a plurality of sub-pixel regions. The black matrix is disposed on the substrate, and has a plurality of openings exposing the substrate and corresponding to each sub-pixel region respectively. Each color filter covers the substrate exposed by each opening. The patterned common electrode layer is disposed on the black matrix and the color filters, and the patterned common electrode layer includes a plurality of integrated units respectively configured for touch sensing and transferring a common signal.

### BACKGROUND OF THE INVENTION

1. Field of the Invention

The invention relates to a color filter substrate, and more particularly to a color filter substrate having touch-sensing function.

2. Description of the Prior Art

Having man-machine interactive feature, touch panels have been widely used in input interface of various instruments. As application of consumer electronic products developed broadly in recent years, the products applying the touch display panel integrated with the touch panel and displays are increased, such as mobile phones, GPS navigation systems, tablet PCs, PDAs, and laptop PCs. Common technology involves integrating touch panels and liquid crystal display panels to form touch liquid crystal display panels. However, the integration of display panel and touch panel typically involves finishing the production of each unit separately before uniting them together, resulting that the thickness and weight of the final product is strictly limited to the original thickness and weight of each individual unit. Hence, how to effectively reduce the thickness and weight of the touch display panel while lowering the overall fabrication cost has become an important task in this field.

### SUMMARY OF THE INVENTION

It is an objective of the present invention to provide a color filter substrate with touch-sensing function for reducing the thickness and weight of touch display panel while lowering the fabrication cost of the product.

According to a preferred embodiment of the present invention, a color filter substrate with touch-sensing function is disclosed, in which the color filter substrate includes a substrate, a black matrix, a plurality of color filters, and a patterned common electrode layer. The substrate has a plurality of pixel regions arranged as a matrix, in which each pixel region comprises a plurality of sub-pixel regions. The black matrix is disposed on the substrate, in which the black matrix includes a plurality of openings exposing the substrate and corresponding to each sub-pixel region respectively. The color filters are disposed to cover the substrate exposed by the openings. The patterned common electrode layer is disposed on the black matrix and the color filters, in which the patterned common electrode layer includes a plurality of integrated units respectively configured for touch sensing and for transmitting a common signal.

According to another aspect of the present invention, a color filter substrate with touch- sensing function is disclosed. The color filter substrate includes a substrate, a black matrix, a plurality of color filters, a patterned sensing electrode layer, an insulating layer, and a common electrode layer. The substrate has a plurality of pixel regions arranged as a matrix, in which each pixel region comprises a plurality of sub-pixel regions. The black matrix is disposed on the substrate, in which the black matrix has a plurality of openings exposing the substrate and corresponding to each sub-pixel region respectively. The color filters are disposed to cover the substrate exposed by the openings. The patterned sensing electrode layer is disposed on the black matrix and the color filters, in which the patterned sensing electrode layer has a plurality of sensing units, in which each sensing unit includes a signal transmitting electrode for transmitting a touch-sensing signal and a signal receiving electrode for sensing variation in the touch-sensing signal, in which each signal receiving electrode partially surrounds each signal transmitting electrode and the black matrix shields the signal receiving electrodes. The insulating layer is disposed to cover the patterned sensing electrode layer. The common electrode layer is disposed on the insulating layer for transmitting a common signal.

Preferably, the patterned common electrode layer of the color filter substrate of the present invention has a plurality of integrated units for carrying out touch-sensing functions, and by providing common signals and touch-sensing signals to the integrated units, images could be displayed with the presence of array substrate and display medium layer. Ultimately, the color filter substrate of the present invention not only eliminates the fabrication process of combining display panel and touch panel, but also lowering the overall fabrication cost substantially. Moreover, it should be noted that with the design of the touch display panel having color filter substrate of the present invention, no additional touch panel is required to provide touch-sensing functionality thereby reducing the overall thickness and weight of the product.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a cross-sectional view of a touch display panel of the present invention.

FIG. 2 illustrates a top view of a color filter substrate with touch-sensing function according to a first embodiment of the present invention.

FIGS. 3-4 are cross-sectional views of FIG. 2 along the sectional lines AA′ and BB′.

FIG. 5 is a timing diagram illustrating the transmission of common signals and touch-sensing signals carried out by the signal transmitting electrodes.

FIG. 6 illustrates a cross-sectional view of a color filter substrate with touch-sensing function according to a second embodiment of the present invention.

FIG. 7 illustrates a top view of a color filter substrate with touch-sensing function according to a third embodiment of the present invention.

FIG. 8 illustrates a top view of a color filter substrate with touch-sensing function according to a fourth embodiment of the present invention.

FIG. 9 illustrates a top view of a color filter substrate with touch-sensing function according to a fifth embodiment of the present invention.

FIG. 10 illustrates a cross-sectional view of a color filter substrate with touch-sensing function according to a sixth embodiment of the present invention.

### DETAILED DESCRIPTION

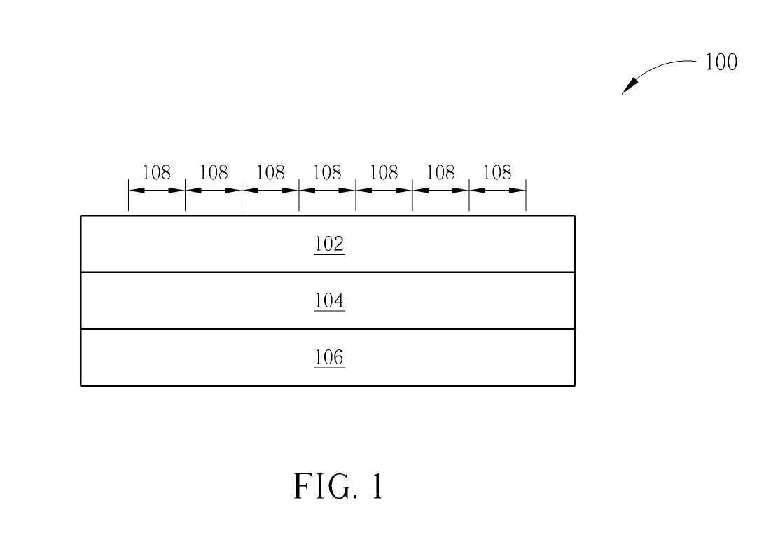

Referring to FIG. 1, FIG. 1 illustrates a cross-sectional view of a touch display panel of the present invention. As shown in FIG. 1, the touch display panel 100 includes a color filter substrate 102, a display medium layer 104, and an array substrate 106. The color filter substrate 102 is positioned opposite to the array substrate 106 respectively, in which the color filter substrate 102 has a touch-sensing function. The display medium layer 104 is disposed between the color filter substrate 102 and the array substrate 106. The touch display panel 100 could include a plurality of pixel regions 108 so that a pixel of a frame is generated in each pixel region 108. Preferably, the material of the display medium layer 104 is used to determine the type of the touch display panel 100. For instance, the display medium layer 104 could include liquid crystal layer, organic light-emitting layer, electrowetting material, electronic ink, or plasma, and the touch display panel 100 could include a liquid crystal display panel, an organic light-emitting diode display panel, an electrowetting display panel, an electronic ink display panel, or a plasma display panel, but not limited thereto. The array substrate 106 could be different depending on the type of touch display panel being used, and since the technology is well known to those skilled in the art, the details of which are omitted herein for the sake of brevity.

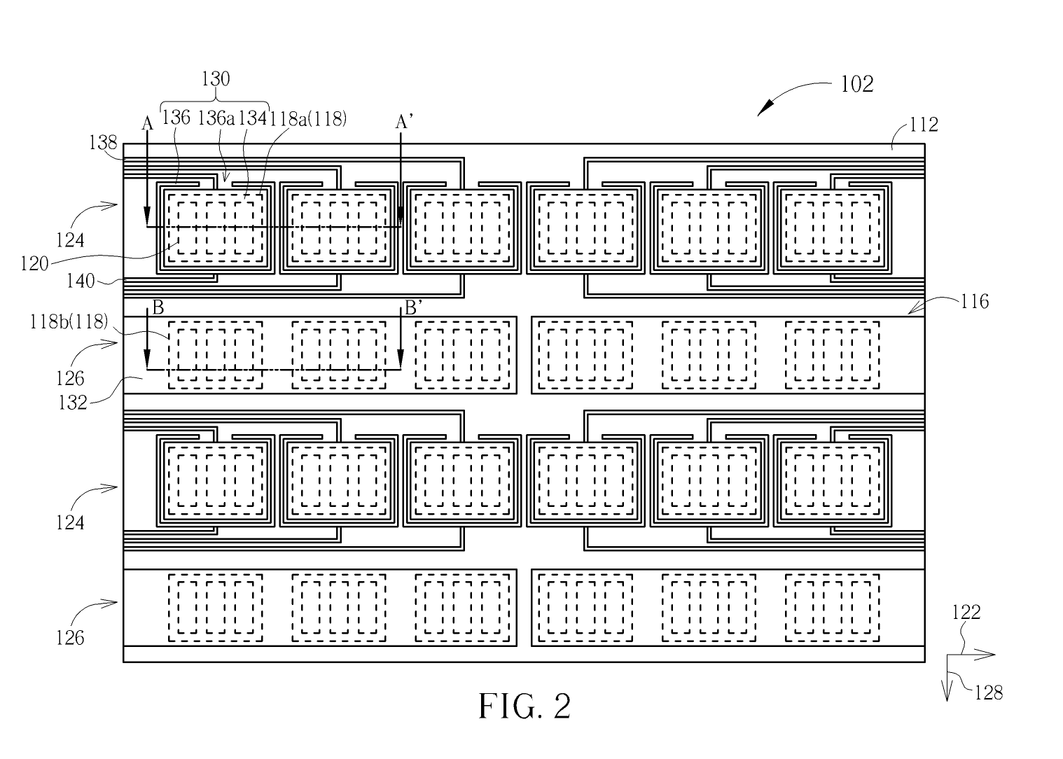

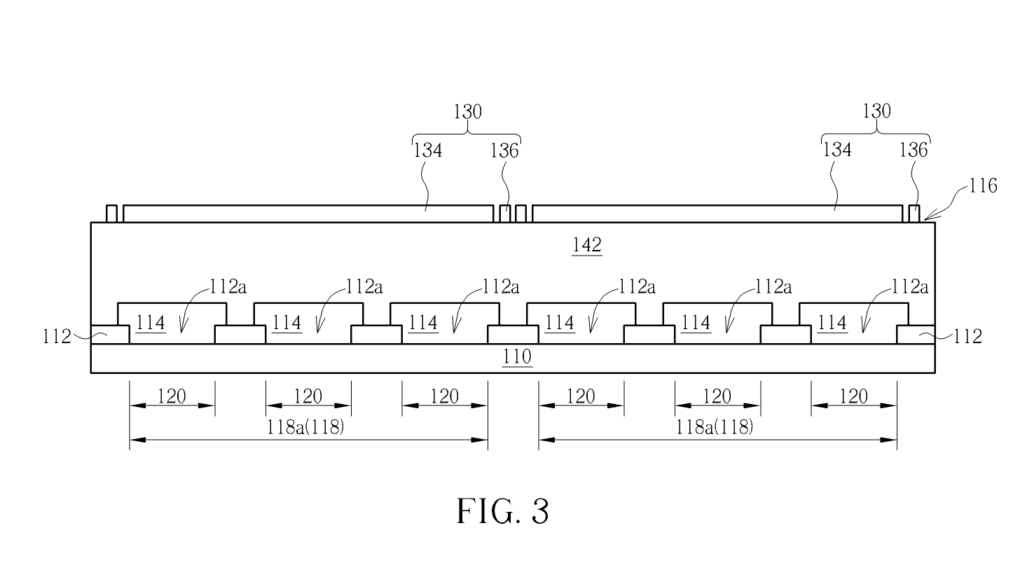

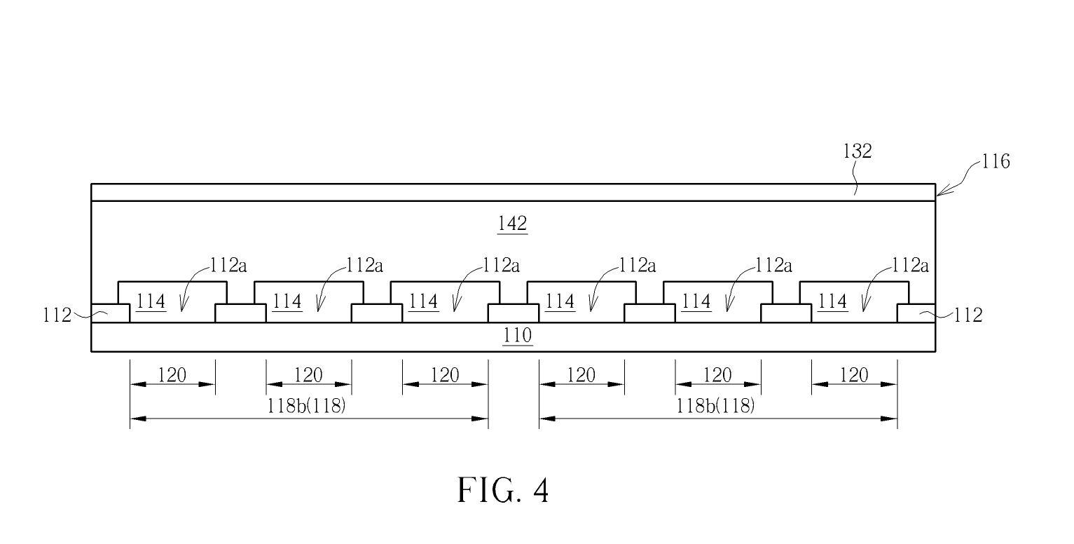

An embodiment with color filter substrate having touch-sensing function and touch display panel 100 being a liquid crystal display penal is explained below, but not limited therein. Referring to FIGS. 2-4 and FIG. 1, FIG. 2 illustrates a top view of a color filter substrate with touch-sensing function according to a first embodiment of the present invention and FIGS. 3-4 are cross-sectional views of FIG. 2 along the sectional lines AA′ and BB′. As shown in FIGS. 1-4, the color filter substrate 102 having touch-sensing function includes a substrate 110, a black matrix 112, a plurality of color filters 114, and a patterned common electrode layer 116. The substrate 110 has a plurality of pixel regions 118 arranged as a matrix, in which the pixel regions 118 are situated corresponding to the pixel regions 108 of the touch display panel 100 and each pixel region 118 includes a plurality of sub-pixel regions 120. The black matrix 112 is situated on one side of the substrate 110 opposite to the array substrate 106, and has a plurality of first openings 112a, in which each first opening 112a is situated to define each sub-pixel region 120 and exposes the substrate 110. Each color filter 114 covers the substrate 110 exposed through each first opening 112a, and the color filters 114 in each pixel region 118 preferably have different colors so that the colors of the color filters 114 in each pixel region 118 could be mixed to generate white color. By controlling the intensity of the light going through each color filter 114 of each sub-pixel region 120, light with different colors could be obtained in each pixel region 118. For instance, each pixel region 118 could be composed of three sub-pixel regions 120 arranged along a first direction 122, such as a row direction. The color filters 114 could be categorized into red color filters, green color filters, and blue color filters, in which each of the red color filters, green color filters, and blue color filters is disposed in each sub-pixel region 120 respectively. According to a modified embodiment of the present invention, the sub-pixel regions in each pixel region could be arranged according to a triangular or mosaic manner. The colors of the color filters in each pixel region could be selected from yellow, cyan, magenta, and other colors, and the quantity of the color filters in each pixel region could be more than four, such as cyan, magenta, yellow, and black, but not limited thereto. Hence, the quantity of the sub-pixel regions could be dependent upon the possible number of combinations being able to generate white color filters. Moreover, the material of the color filters 114 and the black matrix 112 could include photoresist material, but not limited thereto.

In this embodiment, the pixel regions 118 could be divided into a plurality of first pixel regions 118a and a plurality of second pixel regions 118b, in which the first pixel regions 118a are situated in the pixel region 118 of a plurality of first rows 124, and the second pixel regions 118b are situated in the pixel region 118 of a plurality of second rows 126. Preferably, each first row 124 and each second row 126 are arranged alternately along a second direction 128 different from a first direction 112, such as a row direction and a column direction perpendicular thereto.

The patterned common electrode layer 116 is disposed on the black matrix 112 and the color filters 114, in which the patterned common electrode layer 116 includes a plurality of integrated units 130 and a plurality of common electrodes 132. Each integrated unit 130 is disposed corresponding to at least one of the first pixel regions 118a and is used to sense a touch object, such as a finger or a touch pen. Thus, when the touch object approaches the integrated units 130, the integrated units 130 would be able to detect variation in coupled capacitance thereby obtaining the position of the touch object. During an interval of a frame displayed by the touch display panel 100, each integrated unit 130 could not only perform touch-sensing actions but also transmit a common signal, so that a voltage difference could be generated between each integrated unit 130 and the pixel electrodes of the array substrate 106 to drive the liquid crystal layer between each integrated unit 130 and the pixel electrodes of the array substrate 106 for displaying the frame. Preferably, the common electrodes 132 cover the sub-pixel regions 120 within the second pixel regions 118b respectively, such as covering the first opening 112a within the second pixel regions 118b, in which the common electrodes 132 are electrically connected to each other for receiving the common signal so that the liquid crystal layer corresponding to the second pixel regions 118b could be driven by the voltage difference between the corresponding pixel electrodes and the common electrode 132. In this embodiment, each common electrode 132 preferably covers the first opening 112a of a part of the second pixel regions 118b of each second row 126, but not limited thereto. Each common electrode 132 could also cover the first openings of all the second pixel regions of each second row, which is also within the scope of the present invention. The patterned common electrode layer 116 of this embodiment is preferably composed of transparent conductive material, such as indium tin oxide (ITO), indium zinc oxide (IZO), aluminum zinc oxide (AZO), a composite layer of the aforementioned materials or alloys of the aforementioned materials, but not limited thereto. It should be noted that during performing the touch-sensing action, the common electrodes 132 are preferably electrically connected to a grounding terminal to shield the integrated units 130 of two of the first rows adjacent to each other thereby reducing the interference generated therebetween.

In this embodiment, each integrated unit 130 is placed corresponding to each first pixel region 118a, in which each integrated unit 130 includes a signal transmitting electrode 134 and a signal receiving electrode 136. Each signal transmitting electrode 134 preferably covers the sub-pixel regions 120 within each first pixel region 118a, such as covering the first openings 112a within each first pixel region 118a, and each signal receiving electrode 136 partially surrounds each signal transmitting electrode 134. Each signal receiving electrode 136 has a second opening 136a so that the signal transmitting electrodes 134 covering the first openings 112a within the first pixel regions 118 of the same row could be electrically connected to a signal transmitting terminal through the second openings 136a. In other words, the signal transmitting electrodes 134 of the same row are electrically connected to the same signal transmitting terminal, in which each signal transmitting terminal preferably provides a common signal and a touch-sensing signal so that the signal transmitting electrodes 134 could not only transmit the touch-sensing signals but also the common signals. The signal receiving electrodes 136 within the pixel regions 118 of the same column are electrically connected to a signal receiving terminal, and are preferably electrically connected to each other. As a touch object touches the substrate 110 corresponding to a signal transmitting electrode 134, the signal receiving electrode 136 corresponding to this signal transmitting electrode 134 would sense variation of the signal transmitted by this signal transmitting electrode 134 and then transmit the variation of the signal to the signal receiving terminal to determine the location of the object. It should be noted that since the voltage signals transmitted by the signal receiving electrodes 136 are constantly changing, the black matrix 112 is preferably made larger than the signal receiving electrode 136 so that the black matrix 112 could be used to shield the signal receiving electrodes 136. In other words, the signal receiving electrodes 136 are not situated in the sub-pixel regions 120 so that the signals transmitted by the signal receiving electrodes 136 would not affect the illumination variation of the images displayed in each sub-pixel region 120 of the touch display panel 100. It should be noted that the signal receiving electrodes 136 of the integrated units 130 in the pixel regions 118 of the same column are not limited to be electrically connected to each other. Instead, the signal receiving electrodes could also be electrically connected to different signal receiving terminals respectively, which is also within the scope of the present invention. According to a modified embodiment of the present invention, the black matrix could include a hazing layer and a patterned metal layer sequentially formed on the substrate, in which the pattern of the patterned metal layer corresponds to the signal receiving electrodes so that each signal receiving electrode could electrically connect to each signal receiving terminal through the patterned metal layer to lower the resistance generated between each signal receiving electrode and the signal receiving terminal. The patterned metal layer could be composed of metal such as chromium. Preferably, the hazing layer is situated between the substrate and the patterned metal layer to avoid light reflection generated by the metal of the patterned metal layer. The hazing layer is preferably composed of chromium oxide and chromium.

In this embodiment, the patterned common electrode layer 116 could optionally include a plurality of first conductive wires 138 and a plurality of second conductive wires 140. Each first conductive wire 138 is electrically connected to each signal transmitting electrode 134 through each second opening 136a, and the signal transmitting electrodes 134 of the same row are electrically connected to the same signal transmitting terminal. Each second conductive wire 140 is connected to each signal receiving electrode 136 to electrically connect each signal receiving electrode 136 to each signal receiving terminal. Each second conductive wire 140 could be used to electrically connect the signal receiving electrodes 136 of the integrated units 130 in the pixel regions 118 of the same column to each other. In this embodiment, each signal transmitting electrode 134 is electrically connected to each signal transmitting terminal through each first conductive wire 138, but not limited thereto. According to a modified embodiment, of the present invention, the signal transmitting electrodes within the first pixel regions of the same row could also be connected to the same first conductive wire.

The color filter substrate 102 could include a planarization layer 142 disposed between the patterned common electrode layer 116 and the color filters 114 so that the patterned common electrode layer 116 disposed thereon could have a planar surface underneath. The planarization layer 142 could be composed of insulating materials such as photoresist materials, organic materials, nitrides, oxides, or oxynitrides.

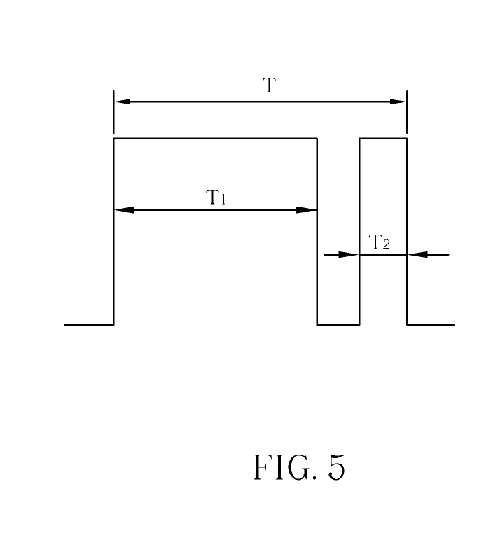

An operating method of the color filter substrate with touch-sensing function of the present invention for touch-sensing is disclosed below. Referring to FIGS. 4-5, FIG. 5 is a timing diagram illustrating the signal transmitted by the signal transmitting electrodes. As shown in FIGS. 4-5, a period T for displaying a single image could include a display interval T1 and a touch-sensing interval T2. Each signal transmitting terminal provides the common signal to the signal transmitting electrodes 134 in the display interval T1, and provides the touch-sensing signal to the signal transmitting electrodes 134 respectively in the touch-sensing interval T2. In the display interval T1, the signal transmitting terminals transmit the common signal to each signal transmitting electrode 134 and the common electrodes 132 thereby keeping each signal transmitting electrode 134 and the common electrodes 132 being of the same potential, and images could be shown on the touch display panel 100. In the touch-sensing interval T2, the signal transmitting terminals provide the touch-sensing signals to the signal transmitting electrodes 134 respectively, and the corresponding signal receiving electrode 136 could detect the relative location of the touch object through sensing the signal variation. Since thin film transistors on the array substrate 106 are turned off during this period, the corresponding pixel electrodes are floating. The images displayed on the touch display panel 100 could be still shown temporarily even though voltage difference is observed as touch-sensing signals are transmitted by the signal transmitting electrodes 134. Essentially, the signal transmitting electrodes of this present embodiment could not only be used on image displays but also on touch-sensing.

It is clearly shown from the above embodiment that by patterning an entire common electrode layer to form the patterned common electrode layer 116, the color filter substrate 102 now not only have a touch-sensing function but also is able to show images in combination with the array substrate and the display medium layer. Hence, the color filter substrate 102 not only save the process for assembling the display panel and the touch panel, but also lowers the material cost of the touch panel. It should be noted that with the design of the touch display panel 100 having the color filter substrate 102, no additional touch panel is required to provide touch-sensing functionality thereby reducing the overall thickness and weight of the product.

The color filter substrate of the present invention is not limited to the embodiment disclosed above. Additional embodiments and variations are disclosed below to emphasize the difference between different embodiments. It should be noted that same numerals are used for the same elements that have been disclosed above, and the details of which are not further explained herein for the sake of brevity.

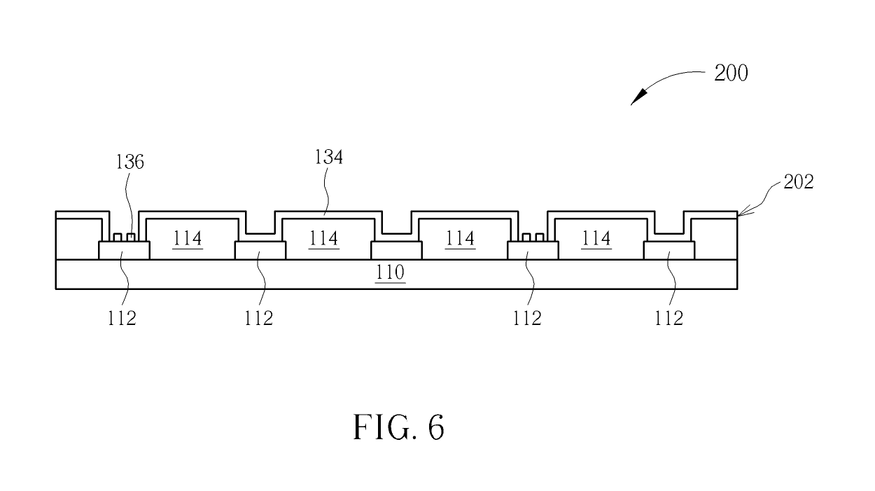

Referring to FIG. 6, FIG. 6 illustrates a cross-sectional view of a color filter substrate with touch-sensing function according to a second embodiment of the present invention. As shown in FIG. 6, the color filter substrate 200 does not include a planarization layer, so that the patterned common electrode layer 202 is situated directly on the color filters 114 and the black matrix 112.

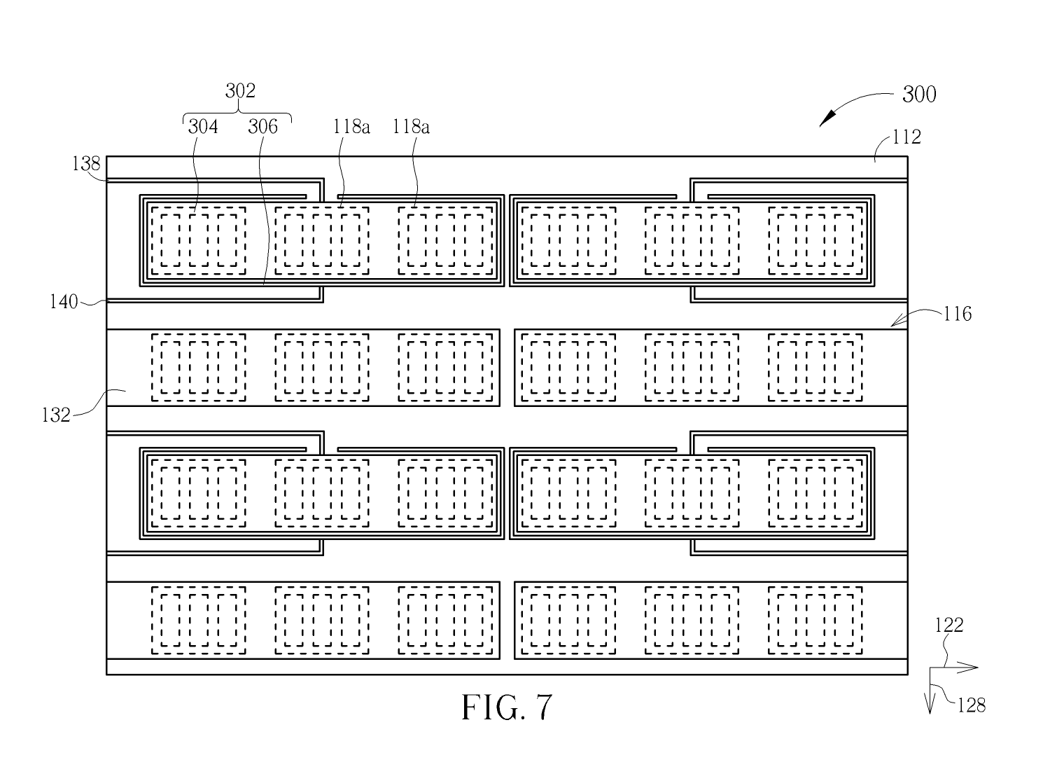

Referring to FIG. 7, FIG. 7 illustrates a top view of a color filter substrate with touch-sensing function according to a third embodiment of the present invention. As shown in FIG. 7, as compared with the first embodiment, the integrated units 302 of the color filter substrate 300 in this embodiment are placed corresponding to a plurality of first pixel regions 118a, in which the signal transmitting electrodes 304 are disposed to cover the first openings 112a of the firs pixel regions 118a. The signal receiving electrodes 306 are placed to partially surround the signal transmitting electrodes 304. For instance, the signal transmitting electrodes 304 could cover the first openings 112a within the three first pixel region 118a so that the integrated units 302 would correspond to three first pixel regions 118a. Since the size of the touch object is typically larger than the size of a single first pixel region 118a, the quantity of the integrated units 302 could be reduced to further lower the quantity of the signal receiving terminals and reduce the burden of the control units electrically connected to the signal receiving terminals through enlarging the size of the integrated unit 302.

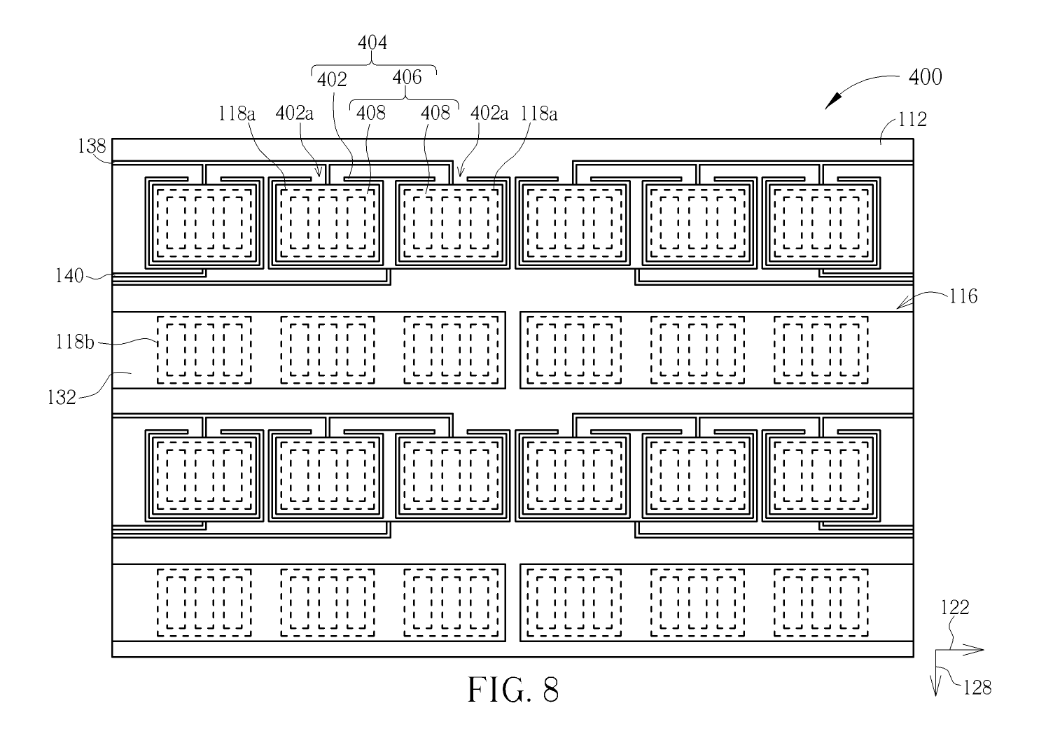

Referring to FIG. 8, FIG. 8 illustrates a top view of a color filter substrate with touch-sensing function according to a fourth embodiment of the present invention. As shown in FIG. 8, as compared with the first embodiment, the color filter substrate 400 of this embodiment electrically connects at least two of the signal receiving electrodes in the same row from the first embodiment to form a single signal receiving electrode 402. In other words, each integrated unit 404 is placed to correspond to a plurality of first pixel regions 118a and each signal transmitting electrode 406 could include a plurality of sensing pads 408 corresponding to each first pixel region 118a respectively. Each signal receiving electrode 402 is situated to surround each sensing pad 408 of the corresponding signal transmitting electrodes 406 and has a plurality of second openings 402a. Hence, each signal transmitting electrode 402 of the integrated unit 404 is placed to surround each corresponding first pixel region 118a. According to a modified of the present invention, each signal receiving electrode could only surround the outside of the sensing pads of each signal transmitting electrode but could not be extended to be disposed between the adjacent sensing pads of each corresponding signal transmitting electrode.

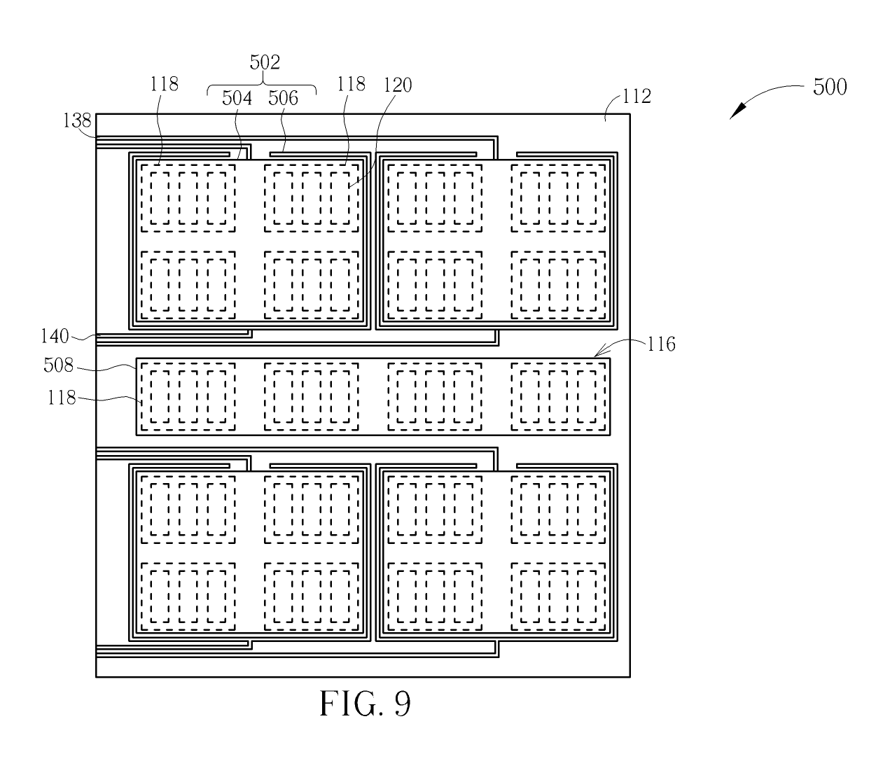

Referring to FIG. 9, FIG. 9 illustrates a top view of a color filter substrate with touch-sensing function according to a fifth embodiment of the present invention. As shown in FIG. 9, as compared with the first embodiment, each integrated unit 502 of the color filter substrate 500 in this embodiment is situated corresponding to at least two adjacent pixel regions 118 of two adjacent rows. In other words, each signal transmitting electrode 504 could cover the first openings 112a within at least two adjacent pixel regions 108 in two adjacent rows respectively, in which each signal receiving electrode 506 partially surrounds each signal transmitting electrode 504 respectively. The pixel regions 118 of a row is disposed between the integrated units 502 of any two adjacent rows, and each common electrode 508 is disposed to cover the pixel regions 118 between the integrated units 502 of any two adjacent rows. For instance, the signal transmitting electrodes 504 situated in the same column cover the pixel regions 118 in the (3n−2)^{th} row (2n−1)^{th} _{column and the (}2n+1)^{th} column, and (3n−1)^{th} row (2n−1)^{th} column and (2n+1)^{th} column while the common electrodes 508 are disposed to cover the pixel regions 118 in the (3n)^{th} row, in which n is positive integer. It should be noted that the integrated units of the present invention are not limited to correspond to pixel regions of two adjacent rows, but could also correspond to a plurality of pixel regions of different rows or different columns, which is also within the scope of the present invention.

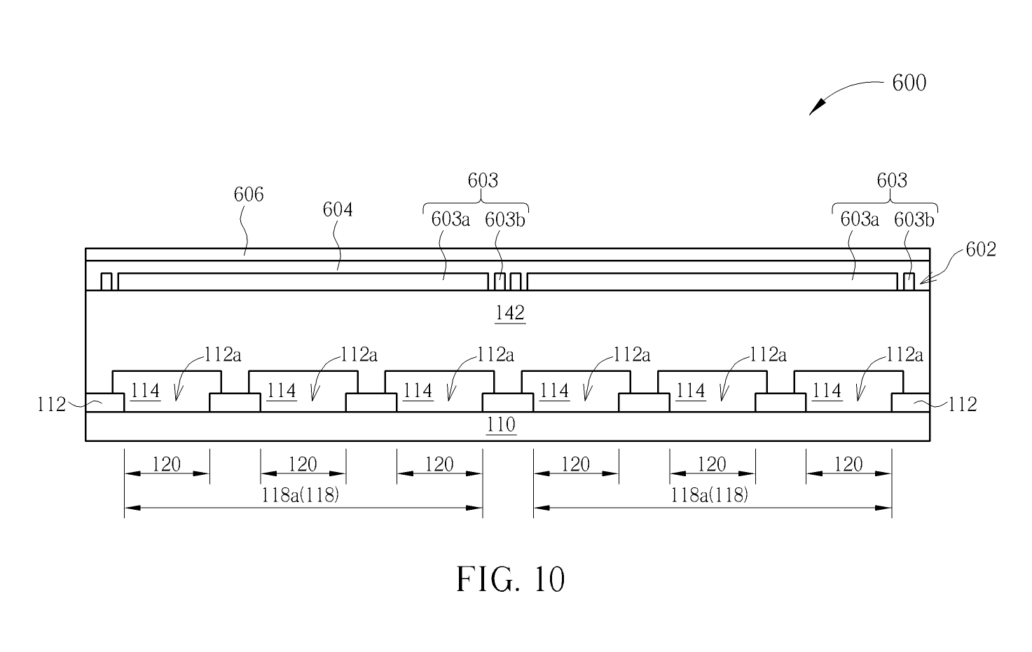

Referring to FIG. 10, FIG. 10 illustrates a cross-sectional view of a color filter substrate with touch-sensing function according to a sixth embodiment of the present invention. As shown in FIG. 10, as compared with the first embodiment, the color filter substrate 600 in this embodiment does not transmit the common signal in the patterned common electrode layer as disclosed in the first embodiment, instead of only transmitting the touch-sensing signals. Therefore, the color filter substrate 600 not only includes substrate 110, color filters 114, and black matrix 112, but also a patterned sensing electrode layer 602, an insulating layer 604, and a common electrode layer 606. In this embodiment, the patterned sensing electrode layer 602 includes a plurality of sensing units 603, in which each sensing unit 603 could have identical pattern as any integrated unit disclosed in the above-mentioned embodiments, such as having a signal transmitting electrode 603a and a signal receiving electrode 603b to performing touch-sensing functions. Since the color filter substrate 600 further includes a common electrode layer 606, the sensing units 603 could be used solely for touch-sensing function. The insulating layer 604 is disposed on the patterned sensing electrode layer 602, in which the insulating layer 604 could be composed of insulating materials such as photoresist material, organic material, nitrides, oxides, or oxynitrides for electrically insulating the patterned sensing electrode layer 602 from the common electrode layer 606. The common electrode layer 606 is disposed on the insulating layer 604 for transmitting the common signal, in which the common electrode layer 606 could be composed of a transparent conductive material such as indium tin oxide (ITO), indium zinc oxide (IZO), aluminum zinc oxide (AZO), a composite layer of the aforementioned materials or alloys of the aforementioned materials, but not limited thereto.

Overall, the color filter substrate of the present invention patterns an entire common electrode layer to include a plurality of integrated units for performing the touch-sensing function, and by providing the common signal and the touch-sensing signals to the integrated units respectively, images could be displayed in combination with the array substrate and the display medium layer. Moreover, the color filter substrate of the present invention not only eliminates the process for assembling the display panel and the touch panel, but also lowers the material cost of the touch panel. Also, it should be noted that with the design of the touch display panel having color filter substrate of the present invention, no additional touch panel is required to provide touch-sensing functionality thereby reducing the overall thickness and weight of the product.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A color filter substrate with touch-sensing function, comprising:
a substrate having a plurality of pixel regions arranged as a matrix, wherein each pixel region comprises a plurality of sub-pixel regions;
a black matrix disposed on the substrate, wherein the black matrix comprises a plurality of openings exposing the substrate, and each opening corresponds to each sub-pixel region respectively;
a plurality of color filters, each of color filter covering the substrate exposed by each opening respectively; and
a patterned common electrode layer disposed on the black matrix and the color filters, wherein the patterned common electrode layer comprises a plurality of integrated units respectively configured for touch sensing and for transmitting a common signal.

2. The color filter substrate with touch-sensing function according to claim 1, wherein each integrated unit comprises a signal transmitting electrode for transmitting the common signal and a touch-sensing signal and a signal receiving electrode for sensing variation of the touch-sensing signal, and each signal receiving electrode partially surrounds each signal transmitting electrode.

3. The color filter substrate with touch-sensing function according to claim 2, wherein the black matrix shields the signal receiving electrode.

4. The color filter substrate with touch-sensing function according to claim 2, wherein each signal transmitting electrode covers the openings in each pixel region respectively.

5. The color filter substrate with touch-sensing function according to claim 4, wherein the signal transmitting electrodes covering the openings situated in the pixel regions of a same row are electrically connected to each other.

6. The color filter substrate with touch-sensing function according to claim 2, wherein each signal transmitting electrode covers the openings in at least two of the pixel regions adjacent to each other respectively.

7. The color filter substrate with touch-sensing function according to claim 2, wherein the signal receiving electrodes of the integrated units corresponding to the pixel regions of a same column are electrically connected to each other.

8. The color filter substrate with touch-sensing function according to claim 1, further comprising a planarization layer disposed between the patterned common electrode layer and the color filters.

9. The color filter substrate with touch-sensing function according to claim 1, wherein the pixel regions comprise a plurality of first pixel regions and a plurality of second pixel regions, wherein the first pixel regions are situated in the pixel regions of a plurality of first rows, the second pixel regions are situated in the pixel regions of a plurality of second rows, each first row and each second row are arranged alternately along a column direction, and each integrated unit is situated corresponding to at least one of the first pixel regions.

10. The color filter substrate with touch-sensing function according to claim 9, wherein the patterned common electrode layer further comprises a plurality of common electrodes electrically connected to each other and covering the openings in the second pixel regions.

11. A color filter substrate with touch-sensing function, comprising:
a substrate having a plurality of pixel regions arranged as a matrix, wherein each pixel region comprises a plurality of sub-pixel regions;
a black matrix disposed on the substrate, wherein the black matrix comprises a plurality of openings exposing the substrate, and each opening corresponds to each sub-pixel region respectively;
a plurality of color filters, each color filter covering the substrate exposed by each opening;
a patterned sensing electrode layer disposed on the black matrix and the color filters, and the patterned sensing electrode layer comprising a plurality of sensing units, wherein each sensing unit comprises a signal transmitting electrode for transmitting a touch-sensing signal and a signal receiving electrode for sensing variation of the touch-sensing signal, wherein each signal receiving electrode partially surrounds each signal transmitting electrode, and the black matrix shields the signal receiving electrodes;
an insulating layer covering the patterned sensing electrode layer; and
a common electrode layer disposed on the insulating layer for transmitting a common signal.

12. The color filter substrate with touch-sensing function according to claim 11, wherein each signal transmitting electrode covers the openings in each pixel region respectively.

13. The color filter substrate with touch-sensing function according to claim 12, wherein the signal transmitting electrodes covering the openings in the pixel regions of a same row are electrically connected to each other.

14. The color filter substrate with touch-sensing function according to claim 11, wherein each signal transmitting electrode covers the openings in at least two of the pixel regions adjacent to each other.

15. The color filter substrate with touch-sensing function according to claim 11, wherein the signal receiving electrodes of the sensing units corresponding to the pixel regions of a same column are electrically connected to each other.

16. The color filter substrate with touch-sensing function according to claim 11, further comprising a planarization layer disposed between the patterned sensing electrode layer and the color filters.
